(19) United States
(12) Patent Application Publication
(10) Pub. No.: US 2024/0416734 A1
(43) Pub. Date: Dec. 19, 2024

(54) Auto Vision Assembly

(71) Applicant: Josiah Collier, Roseville, OH (US)

(72) Inventor: Mark T. Roush, Roseville, OH (US)

(73) Assignee: Josiah Collier, Roseville, OH (US)

(21) Appl. No.: 18/209,658

(22) Filed: Jun. 14, 2023

(51) Int. Cl. B60J 11/08

(52) U.S. Cl. CPC B60J 11/08

(57) ABSTRACT

A windshield vision cover and devise to operate the cover. The windshield cover is a transparent plastic film that protects a visible area of the windshield of a vehicle. The devise is a pair of metal tubes that house the plastic film, a mechanical component, and an electrical component. The electrical component sends power to the mechanical component, causing the spool within the tubes to rotate. This moves the plastic film between the tubes, replacing the plastic film covering the visible area of the windshield. This invention allows off-road vehicles to effortlessly maintain visibility without the need for operators to remove a windshield, purchase foldable windshields, purchase disposable windshields, or subject the internal area of the vehicle to debris.

### CROSS-REFERENCE TO RELATED APPLICATIONS

Not Applicable

### BACKGROUND OF THE INVENTION

This invention is directed to solving the problem of maintaining visibility when operating off-road and all-terrain vehicles. UTV's and side-by-side style vehicles generally have a frame on which a windshield may be installed. When a windshield is used and the vehicle operates in dirty, muddy, or sandy terrain the windshield gets obstructed, impeding the operator's ability to see.

Many variants of windshields exist in the prior art. However, the prior art only offers windshields that can be fully removed, or split windshields that can be folded by hinge attachment.

Recreational operation of a UTV or side-by-side will cover a windshield with debris in approximately 10 minutes. Removing or folding the windshield offers clear vision but leaves the passengers vulnerable to debris directly; creating further vision issues as well as a need to subsequently clean the interior of the vehicle as well as clothing.

The present invention solves this problem by protecting a visible area of the windshield from debris. The vision cover is transparent so the operator can see clearly when in use. The vision cover is also disposable, so when the visible area becomes obstructed the operator can operate a device to reset the visible area and maintain visibility.

### BRIEF SUMMARY OF THE INVENTION

This invention is a windshield vision cover and devise. The windshield vision cover is a roll of thin plastic film with transparent qualities that offer visibility as clear as the windshield being protected. The plastic film is attached to two metal tubes that are secured to the vehicle's windshield frame.

The metal tubes have a top portion with a cap and a side portion with a slit. The cap can be removed to place the plastic film inside the tubes or to remove the plastic film after use. The side slits allow the plastic film to pass through the tubes and stretch across the windshield.

The metal tubes also have a spool, a mechanical component, and an electrical component. The spool holds the plastic film within the tubes and allows the film to wrap around the spool when the other components are activated. The mechanical component causes the spool to rotate, which causes the plastic film to unwrap from one spool and wrap around the other spool. The electrical component provides power to the mechanical component, allowing the spool to rotate by button press.

By causing the plastic film to rotate, the operator can clear obstructed vision of the covered area by moving obstructed film into the metal tube and automatically replacing the obstructed film with clear, visible film. This allows operators to maintain a clear visible area of a vehicle without the need to remove the windshield, clean the windshield, or expose the interior of the vehicle to any debris.

### BRIEF DESCRIPTION OF THE SEVERAL VIEWS OF THE DRAWINGS

FIG. 1 is a fragmentary side escalated diagrammatic view of the film tube housings in a closed configuration.

FIG. 2 is a fragmentary side escalated diagrammatic view of the film tube housings in an open configuration.

FIG. 3 is a fragmentary side escalated diagrammatic view of the film tube housings in an open configuration showing various internal components of the housing.

FIG. 4 is a fragmentary top plan diagrammatic view of the film tube housings in an open configuration wherein the opening is oriented in the opposite direction as opposed to FIGS. 3 and 4.

FIG. 5 is a fragmentary top diagrammatic view of the device mounting component.

FIG. 6 is a top plan diagrammatic view of the invention.

FIG. 7 is a fragmentary top plan diagrammatic view of a bearing component used in the invention.

FIG. 8 includes two fragmentary perspective sectional diagrammatic view of the film tube holder within the housing, the first being a top angle, and the second being a bottom angle. FIG. 8 also includes a side plan diagrammatic view of the film tube housing.

FIG. 9 is a fragmentary top plan diagrammatic view of the film tube housing caps.

FIG. 10 is a fragmentary bottom sectional diagrammatic view of the film tube housing without showing the housing caps.

FIG. 11 is a fragmentary side plan diagrammatic view of the lower part of the film tube housing.

FIG. 12 is a fragmentary side plan diagrammatic view of an aluminum rod used in an embodiment of the invention.

FIG. 13 is a fragmentary side plan diagrammatic view of a piano hinge of the film tube housings.

FIG. 14 is a fragmentary side perspective diagrammatic view of the ridgelines found on the bottom side of the windshield track assembly.

FIG. 15 is a fragmentary top perspective diagrammatic view of the windshield track assembly attached to a windshield.

FIG. 16 is a fragmentary side perspective diagrammatic view of the windshield track assembly in an upside-down orientation.

### DETAILED DESCRIPTION OF THE INVENTION

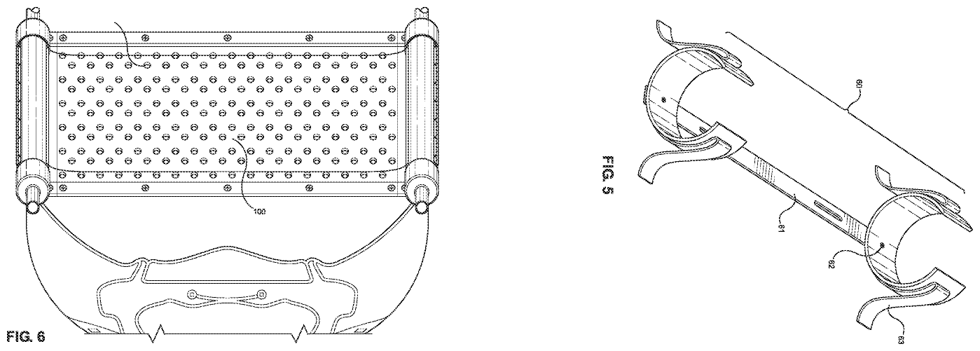

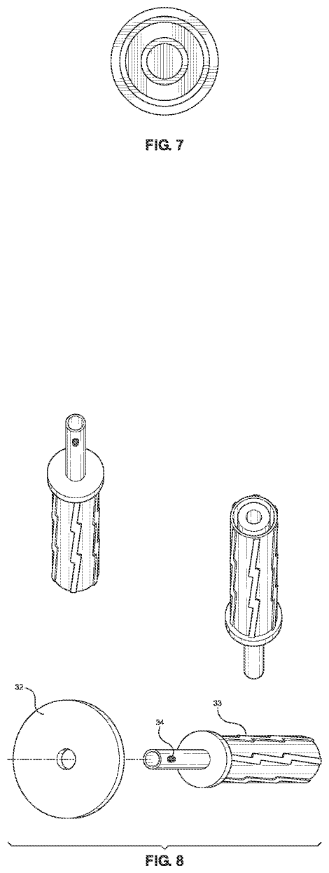

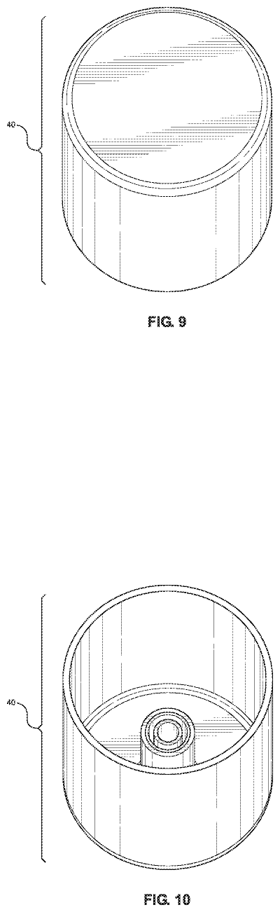

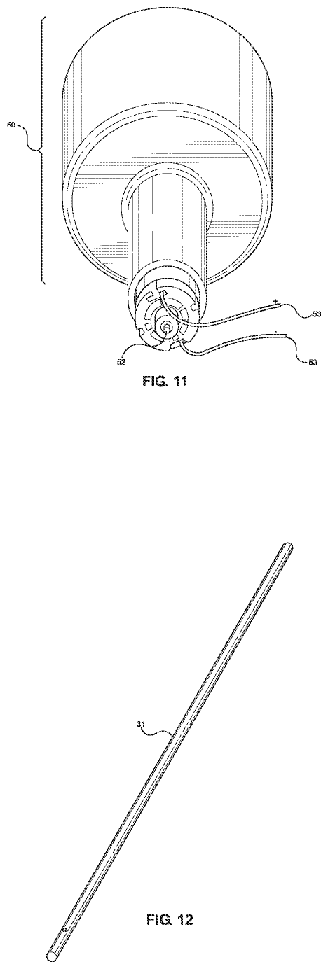

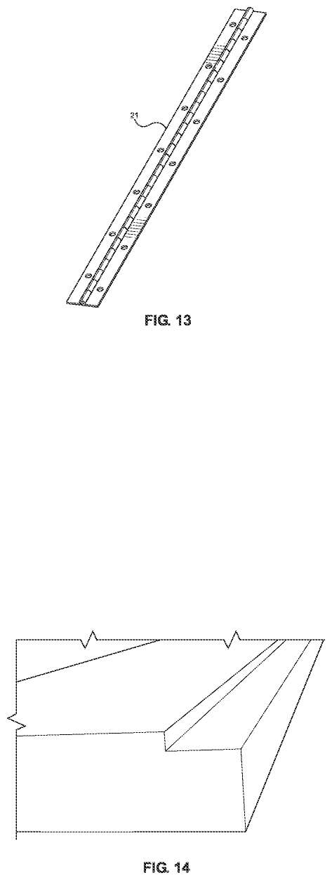

Referring now to FIG. 6 of the drawings, there is shown a preferred embodiment of the present invention being two metal housing units, plastic film 70, a frame to hold the film to the windshield 60, and mounting frames (not shown) attaching the housing units to the windshield.

Referring now to FIG. 5 of the drawings, there is shown a mounting frame 60. The frame 60 is generally a piece of solid material with a straight middle section 61 and two curved ends 64. The curved ends 64 curve horizontally so that the concave portion of the curve is outwardly from the straight middle section 61. The frame 60 is fixed to the windshield of a vehicle by non-detachable means 62, including screws and bolts, at the central area of the curved ends 64. The bottom curved end 64 includes a detachable material 63 used to secure the housing units to the mounting frame.

The preferred embodiment of the mounting frame 60 is made of aluminum stock. The middle section 61 is 1″ wide and 18″ long. The mounting frame 60 is fixed to the vehicle by bolts and lock nuts attached at the central point of the curved ends 64. The detachable material 63 which secures the housing units is made of rubber-backed Velcro.

Referring now to FIG. 1 of the drawings, a housing unit 10 of the film tubes is shown in a closed configuration. The housing unit 10 generally includes a top cap 40, a bottom cap 50, and a middle section 20. The middle section 20 includes a vertical slit 22 on one side of the middle section 20, and a hinge 21 attached vertically to the middle section 20 directly opposite of the vertical slit 22.

In the preferred embodiment, the housing unit 10 comprises a top metal cap 40, a bottom metal cap 50, and a metal cylindrical frame 20. The cylindrical frame 20 is connected by a piano hinge 21 that attaches vertically to the housing unit 10 on one side of the unit. The piano hinge 21 is attached to the housing unit 10 via rivets 24. Directly opposite of the piano hinge 21, there is a vertical slit 22 in the housing unit 10 that allows the film to pass through the housing unit 10.

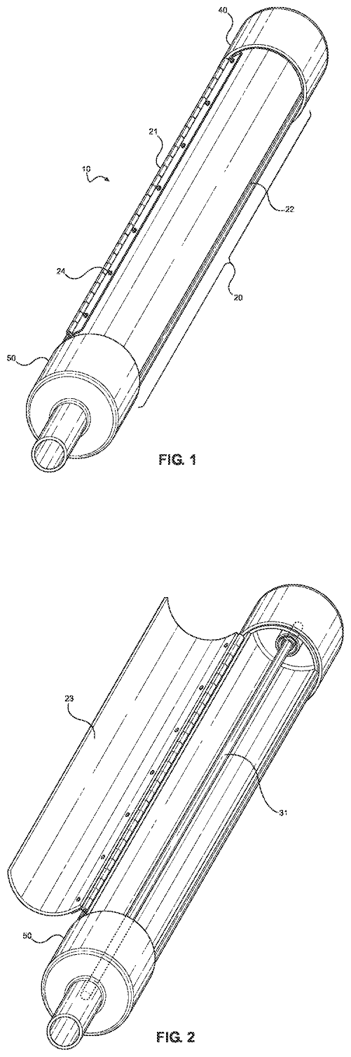

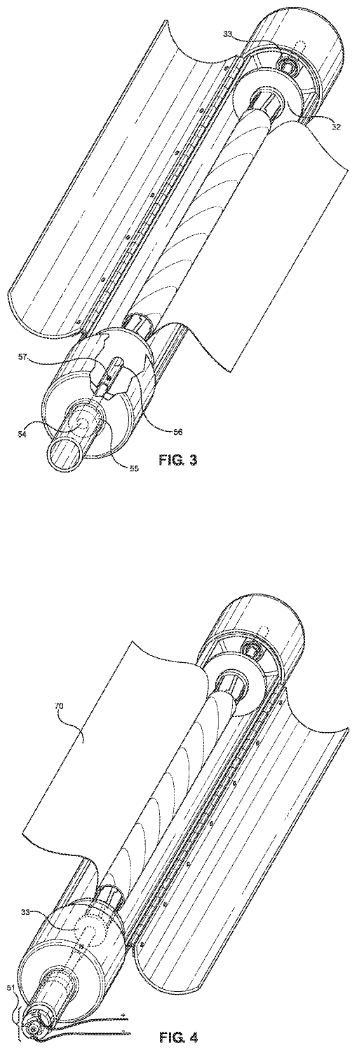

Referring now to FIG. 2 and FIG. 3 of the drawings simultaneously, a housing unit 10 is shown in an open configuration. The middle section 20 can be opened by pulling one side of the vertical slit 22 away from the other side and towards the hinge attachment 21.

The inside of the housing unit 10 generally includes a vertically attached rod 31, a rod bearing 54, a means to attach the rod to the top of the housing 90, film tube holders 33, a film guide 32, a coupling 56, a gear 55, a means to attach the coupling and gear to the rod 90, and a tube of film 70.

The rod 31 runs through the middle of the housing unit 10. The rod 31 inserts into the rod bearing 41, then the coupling 56 within the bottom cap 50. The top portion of the coupling 56 connects to the rod 31. The bottom portion of the coupling 56 connects to the ratchet gear 55. In a preferred embodiment, the means of attaching 90 the rod 31 to the coupling 56 is by set screws, and the means of attaching 90 the coupling 56 to the ratchet gear 55 is by set screws.

There are two film guides 32 within the housing 10. The film guides 32 are generally circular material with a hole in the center that fits over the rod 31. The first film guide 32 is placed on the rod 31 after the bottom portion of the rod 31 is connected to the rod bearing 41.

There are two film tube holders 33 within the housing 10. The film tube holders 33 are generally cylindrical pieces of material that have a hole in the center, which fits over the rod 31. The film tube holders 33 are slightly smaller in diameter than the film roll 70, and generally help the film roll 70 to rotate within the housing 10.

The film tube holders 33 are connected to the rod 31 by means of attachment 90. In the preferred embodiment, the means of attaching 90 the film tube holders 33 to the rod 31 is by set screws.

The first film tube holder 33 is placed over the rod 31 towards the bottom portion of the rod 31 and touching the film guide 32. The film tube holder 33 is then connected to the rod 31 by means of attachment 90.

The second film tube holder 33 is then placed over the rod 31 at the top portion of the rod 31. The film tube holder 33 is then connected to the rod 31 by means of attachment 90.

The second film guide 32 is placed over the rod 31 and touching the top film tube holder 33.

The top cap 40 contains a rod bearing 41 in the center of the cap. The rod bearing 41 is attached to the top cap 40 by a means of attachment 90. In a preferred embodiment, the means of attaching 90 the rod bearing 41 to the top cap 40 is by set screw.

The top cap 40 is removably connected to the rod 31 by placing the top of the rod 31 within the rod bearing 41 of the top cap 40.

Referring now to FIG. 4 of the drawings, the housing unit 10 is shown with an electrical component to power the invention. The electrical component generally includes electrical wires 53 and a small motor 52.

In the preferred embodiment, the motor 52 is a 12-watt motor that fits within a 1¼″ cylinder tube. The electrical wires 53 connect the motor to the gear, and the motor to a power supply within the interior of the vehicle.

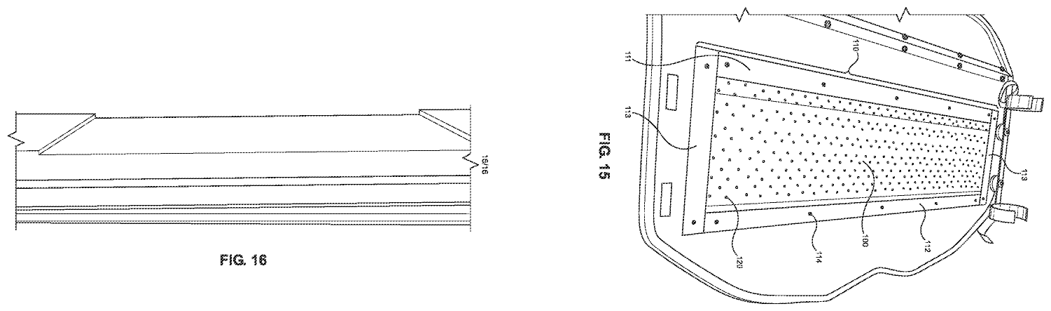

Referring now to FIGS. 14-16, a mounting track assembly 110 is shown, generally consisting of a top portion 111, a bottom portion 112, and two side portions 113. Said top 111, bottom 112, and side portions 113 generally comprise rectangular material made of translucent material and are attached to a windshield by fixed means 114, such as screws.

The top 111 and bottom portions 112 are elongated across a central area of a windshield. Said top portion 111, side portions 113, and bottom portion 112 have a flat top side. Said top 111 and bottom portions 112 have a bottom side with a routed edge creating ridges, the concave portion of said ridges being oriented towards the middle section of the track assembly 110.

Said side portions 113 are attached to a windshield in an orientation perpendicular to the top 111 and bottom portions 112, said side portions 113 being configured to create a flush rectangular area between the top 111, bottom 112, and side portions 113. Said flush rectangular area between the top 111, bottom 112, and side portions 113 is a visible area 100, wherein the present invention protects visibility from dirt and debris.

Spaced apertures 120 are applied directly to the visible area of a windshield by any means capable of creating small apertures in a windshield. Said apertures 120 are configured to be evenly spread across the visible area 100.

In a preferred embodiment, the windshield track assembly 110 is made of plexiglass. The side portions 113 are 2″ in length. The routed edges are 1/16″ deep and 1″ wide. The top portion 111 and bottom portion 112 are 4½ ft long. The side portions 113 are 18″ long.

The best mode to prepare the present invention for use is to first attach the mounting frame 60 to the windshield frame of a vehicle, such as a UTV or side-by-side. The mounting frame 60 is attached vertically to the vehicle's windshield frame. The mounting frame 60 is fixed to the windshield frame by screws or bolts.

The user should then attach the windshield track assembly 110 to the vehicle's windshield. To do so, the user should place the top portion 111 horizontally across the windshield at a slightly lower elevation compared to the top housing insert 64. The user may then place the side portions 113 on the sides of the top portion 111 creating a flush line across the top wherein the top edge of the side portions 113 are of equal elevation to the top edge of the top portion 111. The user can then place the bottom portion 112 in a similar configuration, being of a higher elevation compared to the bottom housing insert 64, and creating a flush line between the bottom edge of the bottom portion 112 and the bottom edge of the side portions 113. Once placed, the user may apply attachment means 62 directly through the windshield track assembly 110 portions to attach the assembly.

Once the windshield track assembly 110 is attached, the user should use any means capable of creating holes in a windshield to create spaced apertures 120 evenly across the visible area 100.

The housing units 10 are placed within the inserts 64 with the small motors 52 and electrical wires 53 on the bottom, and the vertical slits 22 of the housing units 10 facing directly towards the opposing housing unit 10.

The housing units 10 are then secured to the inserts 64 by securing the connective straps 63 around the housing units 10 and connecting the straps 63 to the inserts 64.

Once the housing units 10 are secured to the mounting frame 60, a user can then remove the top cap 40 of one of the housing units 10 and place a film tube 70 into the housing unit 10 and around the film tube holders 33. The user can then replace the top cap 40.

Once the film tube 70 is placed within the housing unit 10, the user should then open both housing units 10 by pulling the sides of the vertical slit 22 away from each other and towards the hinge 21. Once the housing units 10 are open, the user can begin connecting the plastic film 70 to both housing units 10.

To connect the plastic film 70 to both housing units 10, the user should begin unrolling the plastic film 70 while it is inserted in the housing unit 10. The plastic film 70 should be pulled towards the opposite housing unit 10 and should be wrapped around the empty film tube holders 33 of the empty housing unit. The user should tuck the top and bottom edges of the plastic film 70 under the ridges of the windshield track assembly 110 before wrapping the film 70 around the receiving film tube holder 33. The user should wrap the plastic film 70 around the film tube holders 33 of the empty housing unit 10 in a clockwise orientation and should complete at least one full rotation of the plastic film 70 around the empty film tube holders 33.

Once the plastic film 70 is wrapped around the empty film tube holders 33, both housing units 10 should be closed completely.

Once the plastic film 70 is connected to the housing units 10 and the housing units 10 are completely closed, the user should connect the small motor 52 to the vehicle's power supply by inserting the electrical wires 53 through the hood of the vehicle. Once through the hood of the vehicle, the electrical wires 53 can be connected to a fuse box or battery within the vehicle, as well as the button (not shown).

The electrical wire 53 connected to the power supply will power the housing units 10 as well as the button (not shown). When pressed, the button (not shown) will send an electrical signal to the motor 52, which will cause the rod 31 to rotate.

The invention is operated by a single button hold. When a user presses and holds the button, the button sends a signal to the motors 52 to rotate the rod 31 in a clockwise orientation. When the rod 31 begins to rotate, the plastic film 70 also rotates. As the plastic film 70 rotates, it leaves the original housing unit 10 and wraps around the housing unit 10 that was empty. When a user releases the button, the button's signal ceases, the motor 52 stops receiving electricity and thus stop rotating the rod 31.

When a user is operating a vehicle utilizing the invention and the plastic film 70 becomes dirty or obstructed, the user can press and hold the button until the obstructed portion of the plastic film 70 has moved out of the visible area and has been replaced by clear plastic film 70. The user can then repeat this process as needed.

Once the roll of plastic film 70 has been used, the user can simply remove the top caps 40, remove the used plastic film 70 from the originally-empty housing unit 10, place a new roll of plastic film 70 into the originally-full housing unit 10, and connect the plastic film 70 to the empty housing unit 10 as described above.

I claim:

1. A windshield cover comprising:
A roll of thin, translucent, flexible plastic optimal for transparency, said plastic being housed and tautly-fixed between two housing units, said housing units which are secured to the left and right sides of the vehicle frame;
Said roll of plastic film being attached to spools housed within the housing units;
Said housing units being configured to mechanically move the plastic film across a visible area;
A mechanical component housed within said housing units that causes said spools to rotate;
An electrical component that provides electricity to said mechanical component to initiate said rotation;
A button on the inside of the vehicle that, when pressed, signals said electrical component to send electricity to said mechanical component, causing said spool to rotate.
A mounting assembly to attach the housing units to the windshield;

2. A windshield cover as in claim 1, further comprising:
A windshield track assembly configured to guide the plastic film across a visible area, generally comprising a top portion, a bottom portion, two side portions, and spaced apertures;
Said top and bottom portions being rectangular material elongated across a central area of a windshield;
Said top portion, bottom portion, and side portions being made of translucent material;
Said top portion, bottom portion, and side portions being attached to a windshield by fixed means, such as screws;
Said top portion, side portions, and bottom portion having a flat top side;
Said top and bottom portions having a bottom side with a routed edge creating ridges, the concave portion of said ridges being oriented towards the middle section of the track assembly;
Said side portions being attached to a windshield by fixed means in an orientation perpendicular to the top and bottom portions, said side portions being configured to create a flush rectangular area between the top, bottom, and side portions;
Said flush rectangular area between the top, bottom, and side portions being a visible area;
Said spaced apertures being applied directly to the visible area of a windshield by any means capable of creating small apertures in a windshield.

3. Housing units as in claim 1, further comprising:
A top cap, a bottom cap, an outer portion, a hinge, and an inner portion;
Said top and bottom caps having internal threading;
Said outer portion having external threading at both ends that corresponds to the internal threading of said caps;
Said caps attaching to said outer portion by matingly engaging said corresponding threading;
Said outer portion having a thin vertical opening permitting thin plastic to pass through.

4. The inner portion of the housing units as in claim 3, further comprising:
A rod, elongated between and removably attached to the caps;
Two film guides, being circular pieces of material removably attached to the ends of the inner portion just below the external threading;
Said film guides having an aperture in the center being disposed over the rod;
Two film holders, being cylindrical material configured to be disposed within the opening of a spool of standard plastic film;
Said film holders having a hollow inner portion allowing for the holders to be disposed over the rod;
Said film holders being removably attached to the rod and abutting the film guides;
Said film holders being located closer to the middle of the internal section than the film guides.

5. The top and bottom caps as in claim 3, further comprising:
A rod bearing removably attached to the central portion of the caps, configured to engage with the rod and secure the rod within the housing units.

6. The bottom cap as in claim 3, further comprising:
A coupler, removably attached to the rod,
A ratchet gear, removably attached to the coupler, said ratchet gear being configured to rotate the rod when powered by a motor;
A motor connected to the ratchet gear, said motor being configured to cause the ratchet gear to rotate when powered;
Electrical wires attached to the motor, a power source, and a button, said wires configured to provide electricity to the motor when signaled by a button;
A button configured to send a signal to the motor when pressed.

7. A windshield cover comprising:
A roll of thin, translucent, flexible plastic optimal for transparency, said plastic being housed and tautly-fixed between two housing units, said housing units which are secured to the left and right sides of the vehicle frame;
Said roll of plastic film being attached to spools housed within the housing units;
Said housing units being configured to mechanically move the plastic film across a visible area;
A mechanical component housed within said housing units that causes said spools to rotate;
An electrical power component that provides electricity to said mechanical component to initiate said rotation;
A button on the inside of the vehicle that, when pressed, signals said electrical component to send electricity to said mechanical component, causing said spool to rotate;
A mounting assembly to attach the housing units to the windshield;
Said housing units further comprising a top cap, a bottom cap, an outer portion, a hinge, and an inner portion;
Said top and bottom caps having internal threading;
Said outer portion having external threading at both ends that corresponds to the internal threading of said caps;
Said caps attaching to said outer portion by matingly engaging said corresponding threading;
Said outer portion having a thin vertical opening permitting thin plastic to pass through;
Said inner portion of the housing units, further comprising:
A rod, elongated between and removably attached to the caps;
Two film guides, being circular pieces of material removably attached to the ends of the inner portion just below the external threading;
Said film guides having an aperture in the center being disposed over the rod;
Two film holders, being cylindrical material configured to be disposed within the opening of a spool of standard plastic film;
Said film holders having a hollow inner portion allowing for the holders to be disposed over the rod;
Said film holders being removably attached to the rod and abutting the film guides;
Said film holders being located closer to the middle of the internal section than the film guides;
Said top and bottom caps of the housing units, further comprising:
A rod bearing removably attached to the central portion of the caps, configured to engage with the rod and secure the rod within the housing units;
The bottom cap of said housing units, further comprising:
A coupler, removably attached to the rod,
A ratchet gear, removably attached to the coupler, said ratchet gear being configured to rotate the rod when powered by a motor;
A motor connected to the ratchet gear, said motor being configured to cause the ratchet gear to rotate when powered;
Electrical wires attached to the motor, a power source, and a button, said wires configured to provide electricity to the motor when signaled by a button;
A button configured to send a signal to the motor when pressed.

8. A windshield cover as in claim 7, further comprising:
A windshield track assembly configured to guide the plastic film across a visible area, generally comprising a top portion, a bottom portion, two side portions, and spaced apertures;
Said top and bottom portions being rectangular material elongated across a central area of a windshield;
Said top portion, bottom portion, and side portions being made of translucent material;
Said top portion, bottom portion, and side portions being attached to a windshield by fixed means, such as screws;
Said top portion, side portions, and bottom portion having a flat top side;
Said top and bottom portions having a bottom side with a routed edge creating ridges, the concave portion of said ridges being oriented towards the middle section of the track assembly;
Said side portions being attached to a windshield by fixed means in an orientation perpendicular to the top and bottom portions, said side portions being configured to create a flush rectangular area between the top, bottom, and side portions;
Said flush rectangular area between the top, bottom, and side portions being a visible area;
Said spaced apertures being applied directly to the visible area of a windshield by any means capable of creating small apertures in a windshield.

9. A windshield cover comprising:
A roll of thin, translucent, flexible plastic optimal for transparency, said plastic being housed and tautly-fixed between two housing units, said housing units which are secured to the left and right sides of the vehicle frame;
Said roll of plastic film being attached to spools housed within the housing units;
Said housing units being configured to mechanically move the plastic film across a visible area;
A mechanical component housed within said housing units that causes said spools to rotate;
An electrical power component that provides electricity to said mechanical component to initiate said rotation;
A button on the inside of the vehicle that, when pressed, signals said electrical component to send electricity to said mechanical component, causing said spool to rotate;
A mounting assembly to attach the housing units to the windshield;
Said housing units further comprising a top cap, a bottom cap, an outer portion, a hinge, and an inner portion;
Said top and bottom caps having internal threading;
Said outer portion having external threading at both ends that corresponds to the internal threading of said caps;
Said caps attaching to said outer portion by matingly engaging said corresponding threading;
Said outer portion having a thin vertical opening permitting thin plastic to pass through;
Said inner portion of the housing units, further comprising:
A rod, elongated between and removably attached to the caps;
Two film guides, being circular pieces of material removably attached to the ends of the inner portion just below the external threading;
Said film guides having an aperture in the center being disposed over the rod;
Two film holders, being cylindrical material configured to be disposed within the opening of a spool of standard plastic film;
Said film holders having a hollow inner portion allowing for the holders to be disposed over the rod;
Said film holders being removably attached to the rod and abutting the film guides;
Said film holders being located closer to the middle of the internal section than the film guides;
Said top and bottom caps of the housing units, further comprising:
A rod bearing removably attached to the central portion of the caps, configured to engage with the rod and secure the rod within the housing units;
The bottom cap of said housing units, further comprising:
A coupler, removably attached to the rod,
A ratchet gear, removably attached to the coupler, said ratchet gear being configured to rotate the rod when powered by a motor;
A motor connected to the ratchet gear, said motor being configured to cause the ratchet gear to rotate when powered;
Electrical wires attached to the motor, a power source, and a button, said wires configured to provide electricity to the motor when signaled by a button;
A button configured to send a signal to the motor when pressed;
Said windshield cover, further comprising:
A windshield track assembly configured to guide the plastic film across a visible area, generally comprising a top portion, a bottom portion, two side portions, and spaced apertures;
Said top and bottom portions being rectangular material elongated across a central area of a windshield;
Said top portion, bottom portion, and side portions being made of translucent material;
Said top portion, bottom portion, and side portions being attached to a windshield by fixed means, such as screws;
Said top portion, side portions, and bottom portion having a flat top side;
Said top and bottom portions having a bottom side with a routed edge creating ridges, the concave portion of said ridges being oriented towards the middle section of the track assembly;
Said side portions being attached to a windshield by fixed means in an orientation perpendicular to the top and bottom portions, said side portions being configured to create a flush rectangular area between the top, bottom, and side portions;
Said flush rectangular area between the top, bottom, and side portions being a visible area;
Said spaced apertures being applied directly to the visible area of a windshield by any means capable of creating small apertures in a windshield.
